(19) United States
(12) Patent Application Publication
(10) Pub. No.: US 2013/0040068 A1
(43) Pub. Date: Feb. 14, 2013

(54) ELECTRODE AND SEPARATOR MATERIAL FOR LITHIUM-ION CELLS AND METHODS OF PREPARING THE SAME

(71) Applicants: Tim Schaefer, Harztor (DE); Andreas Gutsch, Luedinghausen (DE)

(72) Inventors: Tim Schaefer, Harztor (DE); Andreas Gutsch, Luedinghausen (DE)

(21) Appl. No.: 13/629,809

(22) Filed: Sep. 28, 2012

Related U.S. Application Data
(62) Division of application No. 12/556,170, filed on Sep. 9, 2009.

(30) Foreign Application Priority Data
Sep. 10, 2008 (DE) 10 2008 046 498.8

(51) Int. Cl. H01M 4/04

(52) U.S. Cl. 427/475; 427/58; 427/126.4; 427/126.3

(57) ABSTRACT

A negative electrode for an electrochemical device comprises an active layer which forms a porous outer surface, the outer surface of the active layer being at least partially coated with nanoparticles, and/or an active layer which is at least partially covered by a porous functional layer at least an outer surface whereof is at least partially covered with nanoparticles. Also disclosed is a separator composite material for separating electrodes in an electrochemical device, comprising an essentially self-supporting support layer and a porous functional layer on at least one side of the support layer. An outer surface of the support layer is at least partially coated with nanoparticles on at least one side thereof. This Abstract is not intended to define the invention disclosed in the specification, nor intended to limit the scope of the invention in any way.

### CROSS-REFERENCE TO RELATED APPLICATIONS

The present application is a divisional of U.S. patent application Ser. No. 12/556,170, filed Sep. 9, 2009, which claims priority under 35 U.S.C. §119 of German Patent Application No. 10 2008 046 498.8, filed Sep. 10, 2008; the entire disclosure of these applications is expressly incorporated by reference herein.

### BACKGROUND OF THE INVENTION

1. Field of the Invention

The present invention relates to an electrode for an electrochemical device such as in particular a lithium-ion cell, to a separator composite material for separating electrodes in electro-chemical devices, to a starting material for the formation of an active layer of a negative electrode, to a paste for preparing an active layer, and to an electrochemical device, in particular a lithium-ion cell for a lithium-ion battery, respectively accumulator.

2. Discussion of Background Information

During operation of a cell, a layer is formed on the negative electrode, the so-called SEI-film (Solid Electrolyte Interface). This layer is formed on any negative electrode if the electrical potential of approximately one volt against lithium metal is under-run for the first time. The SEI-film is an important factor that may influence (limit) the durability of lithium cells.

With regard to the known properties of lithium-ion cells for batteries, respectively accumulators, it would be advantageous to have available lithium-ion cells which are thermally more stable and more durable.

It has been found by the present inventors that this problem can be solved by encasing the negative electrode (anode) by a layer that is coated with nanoparticles. The nanoparticles may be directly applied onto the outer surface of the active layer of the negative electrode, or onto a support layer of a separator composite material, which is arranged on or before the active layer of the negative electrode. In order to obtain an active layer directly coated with nanoparticles, the active layer of a non-completed negative electrode may be coated with nanoparticles, or the active bulk particles from which the active layer is prepared, may be coated with nanoparticles, and then the active layer may be formed from the active bulk particles that are coated with nanoparticles, for example by processing the active bulk particles that are coated with nanoparticles to a paste, which then is applied onto a sink of the negative electrode, dried and cured.

For preparing a separator composite material comprising a nanoparticle coating, a self-supporting support layer may be coated with particles on one side or on both sides prior to the application of a porous layer.

### SUMMARY OF THE INVENTION

The present invention provides a (first) negative electrode for an electrochemical device, in particular a lithium-ion battery. The negative electrode comprises an active layer which forms a porous outer surface. The outer surface of the active layer is at least partially (e.g., sectionally) coated with nanoparticles.

In one aspect of the negative electrode, the nanoparticles may comprise one or more of aluminum oxide, zirconium oxide, and silicon (di)oxide.

In another aspect, the active layer may consists essentially of active bulk particles which adhere to one another, and the outer surface of the active layer may be formed essentially by surfaces of the active bulk particles that are exposed to the outside of the active layer. In one aspect, at least active bulk particles of the top particle layer may be coated with nanoparticles substantially on all sides thereof. In another aspect, substantially all active bulk particles of the active layer may be coated with nanoparticles substantially on all sides thereof.

In yet another aspect of the negative electrode of the present invention, the active layer may be covered at least partially (e.g., at least in partial sections) by a porous functional layer that, during operation of the negative electrode, is suitable in particular, for at least one of receiving the electrolyte, ion conductance, and as an electron barrier.

The present invention also provides a (second) negative electrode for an electrochemical device, in particular a lithium-ion battery. The negative electrode comprises an active layer which is at least partially (e.g., at least sectionally) covered by a porous functional layer that, during operation of the electrochemical device, is suitable in particular for at least one of receiving an electrolyte, ion conductance, and as an electron barrier. At least the outer surface of the porous functional layer is at least partially (e.g., at least sectionally) covered with nanoparticles.

In one aspect of the negative electrode, the nanoparticles may comprise one or more of aluminum oxide, zirconium oxide, and silicon (di)oxide.

In another aspect of the (second) negative electrode of the present invention, the porous functional layer may consists essentially of coating particles, and the outer surface of the porous functional layer may be essentially formed by the surfaces of coating particles that are exposed to the outside of the porous functional layer. In one aspect, at least coating particles of the top particle layer of the porous functional layer may be coated with nanoparticles substantially on all sides thereof. In another aspect, substantially all coating particles forming the porous functional layer may be coated with nanoparticles substantially on all sides thereof.

The present invention also provides a separator composite material for separating electrodes in an electrochemical device, in particular a lithium-ion battery. The composite material comprises an essentially self-supporting support layer and a porous functional layer on at least one side of the support layer. The functional layer, during operation of the electrochemical device, is suitable in particular for at least one of receiving an electrolyte, ion conductance, and as an electron barrier. The outer surface of the support layer is at least partially (e.g., in at least partial sections thereof) coated with nanoparticles on at least one side thereof.

In one aspect of the separator composite material, the nanoparticles may comprise one or more of aluminum oxide, zirconium oxide, and silicon (di)oxide.

In another aspect, the support layer may be at least partially (e.g., at least in partial sections) coated with nanoparticles on the side which carries the porous functional layer and/or the support layer may be at least partially (e.g., at least in partial sections) coated with nanoparticles on the side which is opposite to a side which carries the porous functional layer.

In yet another aspect, the support layer may consist essentially of support fibers, and the outer surface of the support layer may be formed substantially by surfaces of the support fibers that are exposed to the outside of the support layer. In another aspect, at least support fibers of the top fiber layer may be coated with nanoparticles substantially on all sides thereof. In yet another aspect, substantially all support fibers may be coated with nanoparticles substantially on all sides thereof.

In a still further aspect of the separator composite material of the present invention, the support layer may comprise woven support fibers and/or non-woven support fibers. For example, the support fibers may comprise steel wires which are suitable for forming a woven material (e.g., stainless steel wires) and/or polymer fibers. Further, the support layer may comprise a stainless steel woven material and/or a polymeric non-woven material.

The present invention also provides a (third) negative electrode for an electrochemical device, in particular a lithium-ion battery, which negative electrode comprises an active layer which is at least partially covered by the separator composite material of the present invention as set forth above (including the various aspects thereof).

The present invention also provides a starting material for forming an active layer of a negative electrode for an electrochemical device, in particular a lithium-ion battery, which starting material comprises active bulk particles that are coated with nanoparticles.

In one aspect of the starting material, the active bulk particles may comprise one or more of graphite, hard carbon, nano-crystalline amorphous silicon, and lithium titanate and/or the nanoparticles may comprise one or more of aluminum oxide, zirconium oxide, and silicon (di)oxide.

The present invention also provides a paste for preparing an active layer of a negative electrode for an electrochemical device, in particular a lithium-ion battery. The paste comprises the starting material of the present invention as set forth above (including the various aspects thereof).

The present invention also provides a (fourth) negative electrode for an electrochemical device, in particular a lithium-ion battery. The negative electrode comprises an outer active layer which is made from the paste of the present invention as set forth above (including the various aspects thereof). Further, at least the outer surface of the active layer is at least partially (e.g., at least sectionally) coated with nanoparticles.

In one aspect of the negative electrode, the active layer may be coated at least partially (e.g., at least in partial sections) with a porous functional layer that, during operation of the negative electrode, is suitable in particular for at least one of receiving the electrolyte, ion conductance, and as an electron barrier.

The present invention also provides an electrochemical device which comprises a negative electrode according to the present invention as set forth above (including the various aspects thereof) or the separator composite material according to the present invention as set forth above (including the various aspects thereof).

The present invention also provides a (first) method of preparing a negative electrode for an electrochemical device, in particular a lithium-ion battery. The method comprises providing a negative electrode comprising an active layer and coating an outer surface of the active layer at least partially (e.g., at least sectionally) with nanoparticles.

In one aspect of the method, the coating with nanoparticles may be effected from a suspension or as powder under the influence of an electrostatic field. In another aspect, the nanoparticles may comprise one or more of aluminum oxide, zirconium oxide, and silicon (di)oxide.

The present invention also provides a (second) method of preparing a negative electrode for an electrochemical device, in particular a lithium-ion battery. The method comprises providing a negative electrode comprising an active layer, coating an outer surface of the active layer at least partially (e.g., at least sectionally) with a porous functional layer that, during operation of the electrochemical device, is suitable in particular for at least one of receiving an electrolyte, ion conductance, and as an electron barrier, and coating an outer surface of the porous layer at least partially (e.g., at least sectionally) with nanoparticles.

In one aspect of the method, the coating with nanoparticles may be effected from a suspension or as powder under the influence of an electrostatic field. In another aspect, the nanoparticles may comprise one or more of aluminum oxide, zirconium oxide, and silicon (di)oxide.

The present invention also provides a method of preparing a separator composite material for the use in an electrochemical device, in particular a lithium-ion battery. The method comprises at least partially coating an essentially self-supporting supporting layer with nanoparticles and applying a porous layer that, during operation of the electrochemical device, is suitable in particular for at least one of receiving an electrolyte, ion conductance, and as an electron barrier, at least partially (e.g., at least sectionally) onto the support layer.

In one aspect of the method, the nanoparticles may comprise one or more of aluminum oxide, zirconium oxide, and silicon (di)oxide.

The present invention also provides a (third) method of preparing a negative electrode for an electrochemical device, in particular a lithium-ion battery. The method comprises coating active bulk particles for the formation of an active layer of the electrochemical device with nanoparticles, processing the coated active bulk particles into a paste, applying the paste onto a self-supporting substrate, and drying and curing the paste to form an active layer.

In one aspect of the method, material and dimensions of the substrate may be selected for the substrate to be suitable as a current conductor of the negative electrode during operation of the electrochemical device. In another aspect, the nanoparticles may comprise one or more of aluminum oxide, zirconium oxide, and silicon (di)oxide.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description making apparent to those skilled in the art how the several forms of the present invention may be embodied in practice.

According to a first aspect of the present invention, a negative electrode for an electrochemical device, in particular a lithium-ion battery, is provided. The negative electrode comprises an active layer forming a porous outer surface; at least the outer surface of the active layer is sectionally coated with nanoparticles.

According to a second aspect of the present invention, a negative electrode for an electrochemical device, in particular a lithium-ion battery, is provided. The negative electrode comprises an outer active surface that at least in partial sections thereof is covered by a porous functional layer. According to the invention, at least the outer surface of the porous layer is at least sectionally coated with nanoparticles; the porous, functional layer may be suitable in particular for receiving an electrolyte, for ion conductance and as barrier for electrons.

According to a third aspect of the present invention, a separator composite material for separating electrodes in electrochemical devices, in particular lithium-ion batteries, is provided. The separator composite material comprises an essentially self-supporting support layer, and a porous functional layer, which is applied onto at least one side of the support layer; the porous functional layer may be suitable in particular for receiving an electrolyte, for ion conductance and as an electron barrier. According to the invention, an outer surface of the support layer is coated at least on one side in at least partial sections with nanoparticles.

Still according to the third aspect, a negative electrode for an electrochemical device, in particular a lithium-ion battery, is provided. The negative electrode comprises an active layer. According to the invention, the active layer is at least in partial sections covered with a separator composite material according to the third aspect of the invention.

According to a fourth aspect of the present invention, a starting material for the formation of an active layer of a negative electrode for an electrochemical device, in particular a lithium-ion battery, is provided, wherein the starting material essentially comprises active bulk particles. According to the invention, the active bulk particles are coated with nanoparticles, in fact prior to the processing of the active bulk particles for the formation of the active layer or a paste for the formation of the active layer.

Still according to the fourth aspect, a paste for preparing an active layer of a negative electrode for an electrochemical device, in particular a lithium-ion battery, is provided. The paste is formed from a starting material, which essentially comprises active bulk particles. According to the invention, the active bulk particles are coated with nanoparticles, in fact prior to the processing of the starting material into the paste.

Still according to the fourth aspect, a negative electrode for an electrochemical device, in particular a lithium-ion battery, is provided, wherein the negative electrode comprises an active layer. According to the invention, the active layer is prepared from a paste according to the fourth aspect of the invention as described above such that at least the outer surface of the active layer is at least sectionally coated with nanoparticles.

In further aspects of the present invention, still the following is provided: An electro-chemical device, in particular a lithium-ion battery, which according to the invention comprises a negative electrode according to one of the above-described aspects, and an electrochemical device, which comprises a separator composite material according to the above-described aspect of the invention.

For the negative electrodes being provided according to the invention, it has been found as a particular advantage during the operation of the electrochemical devices, in particular lithium-ion cells, that the cells usually are thermally more stable and have a good wettability of the surface that is exposed to the electrolyte.

In view of the problems regarding SEI-films known from the prior art, it has further been found that the negative electrodes constructed according to the invention according to the first, second and fourth aspect usually do not form a SEI-film, respectively a detectable SEI-film, and that usually, the negative electrodes produced according to the third aspect of the invention, during operation can keep, respectively maintain, the SEI-film according to the requirements. By means of such negative electrodes prepared according to the invention by means of the application of a layer of nanoparticles, several thousand cycles may usually be achieved without major alteration losses without problems.

The mentioned negative electrode of a lithium-ion battery is the electrode at which during charging the positively charged lithium ions accumulate that are delivered through the electrolyte from the counter electrode (the positive electrode, respectively cathode), and from which during discharging the lithium ions migrate back to the counter electrode.

The mentioned lithium-ion battery may, for example, be a lithium-ion accumulator, a lithium-ion secondary battery, a lithium-ion battery, respectively a lithium-ion cell, from which by means of serial connection, respectively connection in a row of individual lithium-ion cells, batteries or accumulator facilities may be formed. This means that the term lithium-ion battery is used as a general term in the prior art for the conventional, before-mentioned terms.

The mentioned active layer of the negative electrode is the layer in which the electro-chemical processes of the addition of lithium ions during charging occur, respectively the release of lithium ions to the electrolyte during discharging occur. Thereby, the active layer, for example, may comprise (e.g., essentially consist of) one or more of graphite, so-called “hard carbon” (an amorphous carbon modification), and nano-crystallized, amorphous silicon, wherein the lithium ions are accumulated in the before-mentioned materials by so-called intercalation during charging. If the negative electrode comprises graphite, lithium ions migrate during charging between the graphite layers (nC) of the negative electrode, and form with carbon an intercalation compound (LinₓnC). The active layer may also comprise or consist of lithium titanate (Li₄Ti₅O₁₂). Further non-limiting examples of materials for the formation of the active layer include: lithium metal; alloys based on tin; metal nitrides or phosphides being capable of intercalating lithium, such as CoN₃, NiN₃, CuN₃, or FeP₂, nitrides LiₓM_{y}N₂, wherein M, for example, is Mo, Mn or Fe, and preferably x is from about 0.01 to about 1, more preferred from about 0.2 to 0.9, and y=1−x; nitrides Li₃₋ₓMₓN, wherein M is a transition metal and preferably x is from about 0.1 to about 0.9, more preferred from about 0.2 to about 0.8; and/or phosphides LiₓM_{y}P_{z}, wherein M is a metal such as Cu, Mn or Fe, and preferably x is from about 0.01 to about 1, more preferred from about 0.2 to about 0.9, y=1−x; and z is an integral number, which is selected such that the compound has no electrical charge. The active layer may also comprise any mixture of the before-mentioned materials.

The mentioned active bulk particles are the particles, e.g. crystallized particles, of the material forming the active layer, between which the lithium ions accumulate during charging. For graphite as negative electrode material, the active bulk particle may also be a graphite layer. In one electrode completed for the application in a lithium-ion cell, the active bulk particles may also be connected to each other by means of a binder for forming the active layer, respectively may be adhered to one another.

The mentioned porous functional layer may be a layer as provided in the prior art in separator composite materials such as Separion® as a functional layer that is applied to a self-supporting supporting layer. The porous functional layer may particularly fulfil the functions of receiving a partial amount of the electrolyte, of conducting [lithium] ions and of serving as barrier for electrons. This porous, respectively functional layer, which particularly may be suitable for receiving an electrolyte and/or for the ion conductance and/or as electron barrier, may be provided on a support material for forming a separator composite material such that the separator composite material may be sold as separate product, and elsewhere provided negative electrodes may be encased therewith. Alternatively, the porous functional layer may also be directly applied onto the active layer of a negative electrode.

A separator composite material is a material for separating, respectively separation of electrodes in an electrochemical device, in particular a lithium-ion battery, as is e.g. known under the name Separion®, or is e.g. described in WO 2004/021499 or WO 2004/021477, the entire disclosures of which are incorporated by reference herein.

Nanoparticles are particles whose diameter is not larger than about 100 nanometers. Nanoparticles may be be made from, e.g., aluminum oxide (Al₂O₃), zirconium oxide (ZrO₂) or silicon oxide (SiO₂), or a mixture of two or more thereof. In any case, the diameter of the nanoparticles is approximately less by at least one magnitude than the diameter of the particles that, in particular, form the porous layer or the active layer which suitable for at least one of receiving the electrolyte, ion conductance and as an electron barrier.

According to the before-mentioned aspects of the invention, the nanoparticles may comprise or consist of a material that is selected aluminum oxide, zirconium oxide, silicon oxide, or a mixture there of. These materials are relatively cheap and may be obtained in high purity and are particularly suitable for the technical application.

According to the before-mentioned aspects, the active layer may essentially consist of active bulk particles that are adhering to one another, and the outer surface of the active layer is essentially formed by the surfaces of the active bulk particles being exposed to the outside of the active layer. The term “surface being exposed to the outside of the active layer” means the surface of the active bulk particles that form the active layer and that is accessible for the accumulation of the lithium ions.

In one embodiment of a negative electrode according to the first or fourth aspect of the invention, at least the top particle layer of the active bulk particles that form the active layer is essentially coated on all sides with nanoparticles. This may be achieved by the active bulk particles forming the top particle layer having been coated with nanoparticles prior to the formation of the active layer from the active bulk particles. In particular, the active bulk particles forming the active layer may essentially be coated with nanoparticles on all sides. Therewith, the coating with nanoparticles may be performed prior to the preparation of the negative electrode, which in practice may be simpler, respectively also cheaper than the coating of the outer surface of the active layer with nanoparticles on provided negative electrodes.

Advantageously, the active layer may be covered at least in partial sections or also completely by a porous layer that is suitable for at least one of receiving the electrolyte, ion conductance and as an electron barrier. Preferably, said layer is a ceramic layer, in particular a ceramic membrane, which, in particular, may comprise or consist of aluminum oxide (Al₂O₃) and/or silicon oxide (SiO₂). In particular, the porous layer that is suitable for at least one of receiving the electrolyte, ion conductance and as an electron barrier may be the functional layer of separator composite materials.

According to the second aspect of the present invention, wherein the active layer at least in partial sections is covered by a porous, functional layer, which, in particular, is suitable for at least one of receiving an electrolyte, ion conductance and as an electron barrier, and at least the outer surface of the porous functional layer is at least partially covered with nanoparticles, the porous functional layer essentially may consist of coating particles, and the outer surface of the porous functional layer is essentially formed by the surfaces of the coating particles that are exposed to the exterior of the porous layer.

Herein, coating particles mean the particle-like ingredients of the porous functional layer. The term “surface of the coating particles that are exposed to the exterior of the porous layer” means the surface of the coating particles that is wetted by the electrolyte during the operation of the lithium-ion cell.

At least the coating particles forming the top particle layer of the porous functional layer may be essentially coated on all sides with nanoparticles. Also, in essential, all the coating particles forming the porous functional layer may be essentially coated with nanoparticles on all sides.

According to the third aspect of the invention according to which a separator composite material is provided in which, according to the invention, an outer surface of the support layer is at least on one side coated at least in partial sections with nanoparticles, the outer surface of the support layer may be also coated on both sides at least in partial sections with nanoparticles. For such a separator composite material that may be produced as a self-contained product and may be sold as such, it is of equal value by means of which side it is secured to a negative electrode, respectively which side in a completed lithium-ion cell is exposed to the electrolyte.

In one embodiment of the separator composite material, the side of the support layer onto which the porous functional layer is applied, may be coated at least in partial sections with nanoparticles, in fact particularly prior to the application of the porous layer. Thus, it is not necessary to further coat the opposing side of the support layer, and said side serves for the application, respectively for the securing on the negative electrode.

Alternatively, the support layer may be coated on the side opposing the side on which the porous functional layer is applied, at least in partial sections with nanoparticles. Therefore, in a completed lithium-ion cell in which the separator composite material is applied onto the negative electrode, the side of the porous functional layer being exposed to the electrolyte may develop its receiving function regarding the electrolyte, its function regarding the ion conductance and its function regarding the electron barrier, and the nanoparticles that are arranged on the opposing side facing the negative electrode may develop their effect according to the invention influencing the formation of the SEI-layer.

The support layer may essentially consist of support fibers, and the outer surface of the support layer then essentially is formed by the surface of the support fibers that is exposed to the exterior of the support layer. The formation of the support layer from support fibers results in the support layer becoming self-supporting.

At least the top fiber layer of the support fibers forming the support layer may essentially be coated on all sides with nanoparticles. This embodiment is advantageous if a fiber support that is coated with nanoparticles is applied onto a substrate of fiber layers that are not treated with nanoparticles for the formation of the support layer.

Also the support fibers forming the support layer may essentially be coated on all sides with nanoparticles. This embodiment is advantageous, if the coating of the fibers with nanoparticles, in particular, for example, due to adhesion reasons, is effected prior to the processing of the support fibers to the support layer.

The support layer may comprise woven or of non-woven support fibers. Therefore, in the application, woven materials and non-woven materials are possible.

The support fibers may, for example, be polymer fibers and/or suitable steel wires that are suitable for forming a woven material, in particular stainless steel wires. Polymer fibers and steel wires are easily disposable and are cheap starting materials for the formation of the support layer for the separator composite material. Preferably, the support layer is or comprises a stainless steel woven material and/or a polymeric non-woven material. These materials are particularly cheap and are versatilely disposable starting materials for the support layer.

According to the first aspect of the invention, also a process for preparing a negative electrode for an electrochemical device, in particular a lithium-ion battery, is provided. The method comprises the provision of a negative electrode comprising an active layer. According to the invention, an outer surface of the active layer is coated at least in sections with nanoparticles.

In the method according to the first aspect, the coating of the active layer with nanoparticles may be effected, for example, from a suspension or as powder under the influence of an electrostatic field.

According to the second aspect of the invention, also a method for preparing a negative electrode for an electrochemical device, in particular a lithium-ion battery, is provided. The method comprises the provision of a negative electrode comprising an active layer. According to the invention, an outer surface of the active layer is at least sectionally coated with a porous functional layer that during operation of the electrochemical device is suitable in particular for at least one of receiving an electrolyte, ion conductance and as an electron barrier, and an outer surface of the porous functional layer is at least sectionallycoated with nanoparticles.

In the method according to the second aspect, the coating of the porous functional layer with nanoparticles may be effected, for example, from a suspension or as powder under the influence of an electrostatic field.

According to the third aspect of the invention, a method for preparing a separator composite material for the application in an electrochemical device, in particular a lithium-ion battery, is provided. The method comprises the coating according to the invention of an essentially self-supporting support layer at least sectionally with nanoparticles, and the application of a porous functional layer that during operation of the electrochemical device is suitable in particular for at least one of receiving an electrolyte, ion conductance and as an electron barrier, at least sectionally onto the support layer that is at least sectionally coated with nanoparticles.

According to the fourth aspect of the invention, a method for preparing a negative electrode for an electrochemical device, in particular a lithium-ion battery, is provided. The method comprises the coating according to the invention of active bulk particles for the formation of an active layer of the electrochemical device with nanoparticles, the processing of the active bulk particles being coated with nanoparticles to a paste, the application of the paste of the active bulk particles being coated with the nanoparticles onto a self-supporting substrate as well as the drying and curing of the paste for the formation of an active layer of the negative electrode.

The substrate may be selected according to material and dimension such that it serves as current conductor of the negative electrode during operation of the electrochemical device.

In the methods according to the first to the fourth aspect of the invention, the nanoparticles may be prepared, for example, from aluminum oxide, zirconium oxide, silicon oxide, or a mixture thereof.

In the following, the invention is exemplarily described by means of particular embodiments in more detail, however, not limiting.

In a first embodiment of a lithium-ion battery, a negative electrode as support foil onto which the active material is applied, comprises a self-supporting copper foil that during the operation of the lithium-ion cell serves as current conductor. For the formation of the active layer, a paste is prepared, comprising:
“hard carbon” (amorphous carbon modification) as active material predominantly,
PVDF (polyvinylidene fluoride; partially crystalline) as binder; and
carbon black and graphite as additives for conductance.

The paste formed from these ingredients is applied onto the support foil, is dried and cured.

The thus obtained negative electrode (anode) is coated with nanoparticles either from aluminum oxide (Al₂O₃) or zirconium oxide (ZrO₂). For this, the negative electrode is immersed into a suspension prepared from the nanoparticles and is thereby coated, is subsequently dried and cured, and is thereby stabilized.

For making a lithium-ion cell, said negative electrode is inserted into an electrolyte comprising as solvent alkyl carbonates in various ratios (ethylene carbonate, diethyl carbonate, ethylmethyl carbonate), as first additive a radical scavenger, as second additive a SEI-film stabilizer according to the invention, and as conducting salt LiPF₆.

A lithium-ion cell comprising a egative electrode made according to said embodiment may achieve without any problems several thousands of cycles of charging and discharging without major altering losses.

In another embodiment of the invention, a lithium-ion cell is made by using a commercial negative electrode and a separator composite material according to the invention, the support layer of which consists, depending on application, of a stainless steel woven material or of a polymeric non-woven material. In this case the support material is supported with nanoparticles (aluminum oxide or zirconium oxide), is subsequently dried and cured, and is thereby stabilized. Subsequently, as porous functional layer, a stable ceramic is applied as ceramic membrane that consists of aluminum oxide (Al₂O₃) or silicon dioxide (SiO₂).

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of preparing a negative electrode for an electrochemical device, wherein the method comprises providing a negative electrode comprising an active layer, and coating an outer surface of the active layer at least sectionally with nanoparticles.

2. The method of claim 1, wherein the coating with nanoparticles is effected from a suspension or as powder under the influence of an electrostatic field.

3. The method of claim 1, wherein the electrochemical device is a lithium-ion battery.

4. A method of preparing a negative electrode for an electrochemical device, wherein the method comprises providing a negative electrode comprising an active layer, coating an outer surface of the active layer at least partially with a porous functional layer that, during operation of the electrochemical device, is suitable for at least one of receiving an electrolyte, ion conductance, and as an electron barrier, and coating an outer surface of the porous layer at least sectionally with nanoparticles.

5. The method of claim 4, wherein the coating with nanoparticles is effected from a suspension or as powder under the influence of an electrostatic field.

6. The method of claim 4, wherein the electrochemical device is a lithium-ion battery.

7. A method of preparing a negative electrode for an electrochemical device, wherein the method comprises coating active bulk particles for the formation of an active layer of the electrochemical device with nanoparticles, processing the coated active bulk particles into a paste, applying the paste onto a self-supporting substrate, and drying and curing the paste to form an active layer.

8. The method of claim 7, wherein material and dimensions of the substrate are selected for the substrate to be suitable as a current conductor of the negative electrode during operation of the electrochemical device.

9. The method of claim 7, wherein the electrochemical device is a lithium-ion battery.

10. The method of claim 1, wherein the nanoparticles comprise one or more of aluminum oxide, zirconium oxide, and silicon oxide.

11. The method of claim 2, wherein the nanoparticles comprise one or more of aluminum oxide, zirconium oxide, and silicon oxide.

12. The method of claim 3, wherein the nanoparticles comprise one or more of aluminum oxide, zirconium oxide, and silicon oxide.

13. The method of claim 4, wherein the nanoparticles comprise one or more of aluminum oxide, zirconium oxide, and silicon oxide.

14. The method of claim 5, wherein the nanoparticles comprise one or more of aluminum oxide, zirconium oxide, and silicon oxide.

15. The method of claim 6, wherein the nanoparticles comprise one or more of aluminum oxide, zirconium oxide, and silicon oxide.

16. The method of claim 7, wherein the nanoparticles comprise one or more of aluminum oxide, zirconium oxide, and silicon oxide.

17. The method of claim 8, wherein the nanoparticles comprise one or more of aluminum oxide, zirconium oxide, and silicon oxide.

18. The method of claim 9, wherein the nanoparticles comprise one or more of aluminum oxide, zirconium oxide, and silicon oxide.
